(19) United States
(12) Patent Application Publication
(10) Pub. No.: US 2014/0052647 A1
(43) Pub. Date: Feb. 20, 2014

(54) System and Method for Promoting Truth in Public Discourse

(71) Applicant: TRUTH SEAL CORPORATION, Atherton, CA (US)

(72) Inventor: Frederick Hayes-Roth, Atherton, CA (US)

(73) Assignee: TRUTH SEAL CORPORATION, Atherton, CA (US)

(21) Appl. No.: 13/765,699

(22) Filed: Feb. 13, 2013

Related U.S. Application Data
(60) Provisional application No. 61/684,174, filed on Aug. 17, 2012.

(51) Int. Cl. G06Q 50/18; G06Q 20/38

(52) U.S. Cl. CPC G06Q 50/182; G06Q 20/38
USPC 705/309

(57) ABSTRACT

The present invention enables people to propose campaigns for crowd-source funding intended to label some public claim as bogus or to label some public claim that's being widely denied as true. A fee and several inputs are required to submit the proposed campaign application for vetting, review, editing and approval. Approved campaigns are published on a website so people can find them and contribute to them. A cash bounty is offered as a reward to any challenger who can refute (falsify) the campaign message. A fee and several inputs are required to submit a challenge for evaluation and decision. Challenges are processed sequentially until one is sustained (upheld as proving the campaign position is wrong), or until the campaign duration expires. When a challenge is sustained, the bounty is paid to the challenger, other pending challenges are closed and their fees are returned, and the campaign ends as “falsified” (“unsuccessful”). When the campaign duration expires without a sustained challenge, the campaign ends as “successful” and a monetary reward is paid to the campaign creator and the remainder of the unspent bounty is returned to the sponsors in proportion to their contributions to the campaign fund. Sponsors can provide comments and evidence to augment the campaign materials.

### CROSS-REFERENCE TO RELATED APPLICATIONS

The present application claims the benefit of U.S. Provisional Application No. 61/684,174, filed Aug. 17, 2012, by Frederick Hayes-Roth and titled “System and Method for Vetting Public Assertions”, included by reference herein and for which benefit of the priority date is hereby claimed.

### FEDERALLY SPONSORED RESEARCH

Not applicable.

### SEQUENCE LISTING OR PROGRAM

Not applicable.

### FIELD OF INVENTION

The present invention relates to computer implemented systems for assuring and obtaining truthful information in public discourse.

### BACKGROUND OF THE INVENTION

Humanity depends on four critical elements for survival: 1) breathable air, 2) potable water; 3) edible food; and 4) truthful information. While nations of the world have recognized the importance of protecting air, water and food, pollution of the information environment has been allowed to proliferate largely unchecked. The consequence is a diminished trust in public dialogue resulting in part from 1) flagrant deception; 2) manipulation; 3) partisan and polarizing ideologies; 4) lack of sanctions, either positive or negative; and 4) learned helplessness.

### PRIOR ART

### Truth Discernment

Several services exist for the purpose of distinguishing factual statements from incorrect statements and misrepresentations.

JustFacts researches and publishes verifiable facts about the leading public policy issues through the use of a Standards of Credibility to determine what constitutes a credible fact and what does not. The Standards Of Credibility comprise the following attributes: 1) Facts: facts are presented as plain as possible and use language that is clear and precise; 2) Excluded Facts: “facts” excluded are those that are rendered pointless by other facts and those that do not otherwise meet the Standards of Credibility; 3) Accuracy: sources are not used uncritically, and research contains footnotes with direct quotes and/or raw data from the cited sources; 4) Estimates and Minor Discrepancies: these are handled by giving preferentiality to figures that are contrary to their viewpoints and by using the most cautious plausible interpretations of such data; 5) Conclusions and Quotes: quotes are kept within context, conclusions and quotes made by people with vested interests are excluded except to point out inconsistencies and hypocrisy; 6) Incomplete Data: “facts” that do not account for vital contextual information are not included in research; 7) Balance: the goal is comprehensive accuracy as opposed to balance since the goal is to publish verifiable facts regardless of the views they support, not to circulate half-truths and propaganda. However, JustFacts does not allow third parties to initiate a topic, does not provide a market based mechanism for sourcing and validating information, and there is limited negative impact to purveyors of falsehoods.

Factcheck.org is a nonpartisan, nonprofit “consumer advocate” for voters that aims to reduce the level of deception and confusion in U.S. politics. Factcheck.org monitors the factual accuracy of what is said by major U.S. political players in the form of TV ads, debates, speeches, interviews and news releases. Their stated goal is to apply the best practices of both journalism and scholarship, and to increase public knowledge and understanding.

U.S. patent application Ser. No. 13/066,038 to Hayes-Roth provides for a truth-seal affixing system which creates and provides a computer-renderable instance of a truth-seal annotation schema for a truth-seal to be affixed to a digital statement within a digital document. The truth-seal annotation schema instance contains truth-seal values for rendering and displaying the truth-seal of the digital statement within the digital document allowing readers when viewing the digital document to: (i) identify the existence of the truth-seal, and (ii) request or determine truth-seal values of the truth-seal. The truth-seal affixing system further accesses and interprets instances of a truth-seal annotation schema for any affixed truth-seals. A computer program analyses the truth-seals of digital statements of all digital documents in a set to generate a computer accessible output: (i) identifying the existence of truth-seals, and (ii) extracting one or more of truth-seal values of any truth-seals affixed to each of the documents in the set. While this invention does provide a market based mechanism for ensuring integrity of public statements, it does not address crowd sourcing of information to falsify statements made in public discourse.

### Crowd Sourcing

Several services exist for the purpose of crowdsourcing information.

BountyQuest operated as an Internet destination where companies could post large rewards for documents that describe certain information, and would solicit users to provide the documents to collect the rewards. Companies would contact BountyQuest when they needed an important document, such as one that proves whether a patented invention is really new or not. The companies would engage BountyQuest when they wanted to crowd source the acquisition of such a document. The document could be any kind of public information, such as a part of a book, an academic thesis or paper, or a newspaper or magazine article. The Companies would then establish the amount of money or bounty they are willing to pay for the document. BountyQuest would post the bounties on the website, sorted in categories to help users find the ones that they were most likely to win. Users were encouraged to look at the Bounties to find out what is needed to win, look at the bounties to see what documents are currently needed, and then they go look for the documents. Most of the bounties were about patents that affect businesses and consumers. The user would win the bounty by finding and submitting the document. If the user found the right document and submitted it to BountyQuest, BountyQuest would verify that it is the right document, and if verified, pay the user the reward.

Article One Partners uses a crowdsourcing model to resolve patent disputes. One problem in resolving high-stakes patent infringement contentions is that relevant patent portfolios can be too large for a company to rationally assess. Article One Partners addresses the problem by providing a crowd-sourced platform for companies in need of patent research services. Essentially, the company delegates a job to a large network of researchers around the world. If any of Article One's contributors dig up valid material to defend a client, he or she gets paid. So the job is incentivized. Article One Partners claim that where after repeated attempts to invalidate patents using traditional prior art search methods, they find high quality prior art almost 60% of the time, often enabling more favorable settlement terms or successful reexamination of the patent.

### Crowd Funding

Several services exist for the purpose of crowd-funding projects and campaigns. Entrepreneurs, investors, journalists, artists, environmentalists, educators, nonprofits and charities are using these services to fundraise.

Kickstarter targets artists and entrepreneurs who need funding for creative projects. It uses video as a means of sharing projects. A project cannot begin, and no credit cards are charged, until enough pledges have been made to reach the funding target, so as to discourage poorly-executed projects. Project creators induce sponsors by offering rewards, such as “thank you” mentions on their personal blogs, or products from their projects.

IndieGoGo, similar to Kickstarter, also caters to artists and creative entrepreneurs. What's different here is that you can close a project before full funding, but the transaction fees also go up from 4% to 9%. Users can offer unique perks or tax deductions to contributors in lieu of offering profit, but always keep 100% ownership.

Rock The Post is a business social network and crowd-funding platform for entrepreneurs looking to jump-start their start-up or small business by building a strong following and gathering funding. Entrepreneurs can post about their venture or idea and spread the word in an open forum to engage with like-minded individuals. Contributions can come in the form of pledges and/or investments. Best Feature: The in-depth category list allows you to post your business idea specific to its industry. There are currently 36 different categories, many of which cannot be found on other crowd-funding platforms. The unique categories range from home and garden to real estate. By specifying your niche on Rock The Post, your chances of connecting will be maximized. Although the site encourages collaboration and feedback on the open forum, posts require a detailed campaign with no holes or gaps, as well as a video pitch. Small businesses and entrepreneurs looking to jump-start their startup by gaining the support and feedback of like-minded individuals will benefit greatly from this open-forum platform. There is no cost for standard services.

The present invention uses crowd-funding for a special type of project, where every project is focused on a campaign to communicate a message, using advertising and cash rewards to draw attention to the campaign and invite people to claim a reward if they can disprove the campaign claim.

### SUMMARY OF THE INVENTION

The present invention functions as a Marketplace for Truth-telling, enabling participants to “crowd-fund,” organize and execute grass roots campaigns to publicly expose false political and commercial claims and misrepresentations, while reinforcing true claims and rewarding successful campaign creators, sponsors, challengers and defenders. A goal of the present invention is to increase truth and trust throughout the Internet, and the public information space generally, by publicly exposing false claims and reinforcing true claims. A goal of the present invention is to predispose public dialogue toward truth telling.

Campaigns “crowd-fund,” organize, and execute grass roots campaigns to publicly expose false claims, reinforce true claims and reward successful campaign creators, challengers and defenders. There are two types of campaigns: the Bogus Statement (BS) campaign and the True Statement (TS) campaign. The Bogus Statement campaign challenges perpetrators (and supporters) of misinformation (e.g., the President is not a citizen) to prove their claim or endure the harsh light of public exposure as untrustworthy. A defender, providing objective evidence proving the clam, earns a cash reward (bounty) and recognition as a TruthTeller. In the absence of a successful defense, during the allotted time period, the Campaign Creator earns the cash reward and receives recognition as a TruthTeller. The True Statement campaign issues a public statement of fact (e.g., the President is a citizen) and challenges non-believers to prove otherwise. A challenger providing objective evidence negating the fact earns a cash reward (bounty) and recognition as a TruthTeller. In the absence of a successful challenge, the Campaign Creator earns the cash reward and receives recognition as a TruthTeller.

The present invention creates an Internet presence where users can band together to “put money behind their mouths” when they want to counter lies and misinformation in the public sphere. Users create campaigns to highlight that some widely espoused claims are bogus or that some widely denied claims are true, and they raise money to conduct those campaigns using PR, advertising, and cash bounties. Users share their campaigns with others through social networks and Internet posts, and they gain reputations based on the success of their activities in the system. Campaign funding contributions from sponsors are aggregated and debited when aggregate contributions surpass the stated fundraising target (or the minimum target in the case where there might be a range).

The present invention enables people to propose campaigns for crowd-source funding intended to label some public claim as bogus (“BS”) or to label some public claim that's being widely denied as true (“TS”). A fee and several inputs are required to submit the proposed campaign application for vetting, review, editing and approval. Approved campaigns are published on a website so people can find them and contribute to them (“sponsor” the campaigns). Campaigns that surpass their funding goals go “live” which means the elements of the campaign are executed.

An important component of campaigns is a cash bounty that is offered as a reward to any challenger who can refute (falsify) the campaign message. A fee and several inputs are required to submit a challenge for evaluation and decision. Challenges are processed sequentially until one is sustained (upheld as proving the campaign position is wrong), or until the campaign duration expires. When a challenge is sustained, the bounty is paid to the challenger, other pending challenges are closed and their fees are returned, and the campaign ends as “falsified” (“unsuccessful”).

When the campaign duration expires without a sustained challenge, the campaign ends as “successful” and a monetary reward is paid to the campaign creator and the remainder of the unspent bounty is returned to the sponsors in proportion to their contributions to the campaign fund. Sponsors can provide comments and evidence to augment the campaign materials. Participants in any role have registered identities, profiles, histories, and ratings. Company staff members have administrative permissions and access to administrative views that let them edit and approve applications, challenges, and monitor/execute/terminate campaigns and challenges.

Individuals can also have accounts for promotional money (promo-cash) that the company provides to them they can use toward application fees. When money is paid to participants as rewards, returns of leftover cash to sponsors, or challengers, it goes to the participant's account or wallet, and from there it can be paid out upon request through checks mailed to the recipient or other means of funds transfer. Money in an individual's account can be used to pay for any service or fee, in addition to money they might pay.

### BRIEF DESCRIPTION OF THE DRAWINGS

A complete understanding of the present invention may be obtained by reference to the accompanying drawings, when considered in conjunction with the subsequent detailed description, in which:

FIG. 1 is a flowchart illustrating an embodiment of a method in a multi-agent system.

FIG. 2 is system diagram illustrating a multi-agent system.

FIG. 3 is a system diagram illustrating a distributed system.

FIG. 4 is a flowchart illustrating a method for instantiating a campaign.

FIG. 5 is a flowchart illustrating a method for vetting a campaign.

FIG. 6 is a flowchart illustrating a method for sponsoring a campaign.

FIG. 7 is a flowchart illustrating a method for challenging a campaign.

FIG. 8 is a system diagram illustrating an “n-”-tier distributed system.

FIG. 9 is a schematic diagram illustrating a computing apparatus.

FIG. 10 is a schematic diagram illustrating a computing apparatus in more detail.

### DETAILED DESCRIPTION

### Multi-Agent System

In one embodiment of the present invention, a multi-agent system of autonomous software agents cooperate and compete to vet the validity of public assertions or claims in which the vetting process appraises, verifies or checks for truthfulness of the claim In such a system, a claim is input into the system, the agents assess the claim, and through a system of sponsorship and challenges, come to a system determination as to the veracity of the claim. The system is populated with multiple software agents, each with a corpus of information embodied in an intelligent retrieval mechanism such as an expert system, database, or search capability. Each agent may have a different information access profile. Each agent will have the capability of making a determination as to whether a specific claim is true, false, or indeterminate according to its information profile. Each agent will have the capability of communicating the logic and data path followed in making any determination. Each agent has an agent credibility factor which is a numerical rating that is enhanced or degraded depending out the outcome of each system determination. The agent credibility factor can be used to give weight or credibility to the agent, increase or decrease the lifespan of the agent, or some other incentivizing mechanism.

In one embodiment of the invention, once a claim is input into the system, the first agent to determine that the claim is true is designated the asserting agent. The asserting agent will then determine: 1) seed bounty points, being the number of bounty points the asserting agent is contributing to the campaign bounty; 2) funding threshold, being the number of bounty points in addition to the seed bounty points that will be sought from other agents to contribute to the campaign bounty as sponsor bounty points; 3) fundraising period, being the period of time during which agents will be allowed to contribute sponsor bounty points to the campaign to reach the funding threshold; and 4) campaign period, being the period of time during which agents will be allowed to challenge the claim. The campaign bounty is the sum of the seed bounty points and sponsor bounty points. Once an asserting agent has adopted a claim, other agents will assess the claim.

During the fundraising period, if an agent determines that a claim is indeterminate, the agent becomes a neutral agent and no longer interacts with the campaign. If an agent determines that a statement is false, then the agent becomes an opposing agent. In one embodiment of the present invention, the opposing agent contributes an opposition point to the campaign. If an agent determines that a statement is true, then the agent becomes a sponsoring agent. The sponsoring agent makes a determination, based on its current agent credibility factor and its determination confidence factor, on how many sponsorship bounty points to contribute to the campaign bounty.

In one embodiment of the invention, if the funding threshold is not met by the end of the fundraising period because sponsoring agents have not contributed enough sponsorship bounty points to the campaign bounty, the campaign will be terminated and all contributed sponsorship bounty points will be allocated back to the contributing sponsorship agents and all seed bounty points will be allocated back to the asserting agent. The system determination of the claim will then be retired as indeterminate and the campaign will be terminated.

In one embodiment of the present invention, if the funding threshold is met by the end of the fundraising period because sponsoring agents have contributed enough sponsorship bounty points to the campaign bounty, the campaign will be considered active and will proceed to the campaign period. In one embodiment of the invention, the campaign will be considered active at the time that the funding threshold is met. In another embodiment of the invention, the campaign will be considered active at the end of the fundraising period if the funding threshold has been met, and all pledged sponsorship bounty points, including those exceeding the funding threshold, will be allocated to the campaign bounty.

During the campaign period, if an agent determines that a claim is indeterminate, the agent becomes a neutral agent and no longer interacts with the campaign. In one embodiment of the invention, if an agent determines that a statement is true, the agent becomes a supporting agent and allocates one support point to the campaign. If an agent determines that a claim is false, the agent becomes a challenging agent and initiates a challenge by allocating challenge points to the campaign bounty. The challenging agents are placed in a queue in the order in which they make a determination that that the claim is false.

Once a challenging agent has initiated a challenge, the adjudication component processes the claim against the determinations made by the challenging agents in a serial, first-in first-out manner. The adjudication component is a system that is capable of comparing, analyzing and assessing the information provided by asserting agent and challenging agent and coming to a determination as to whether the information provided by the challenging agent is sufficient to falsify the claim adopted by the asserting agent. If the adjudication component makes a determination that a challenging agent has falsified the claim, the campaign bounty is allocated to the challenging agent and the campaign is terminated. If the adjudication component makes a determination that a challenging agent has not falsified the claim, the adjudication component processes the next challenge in the queue in a like manner.

If the campaign period expires and the adjudication component has not made a determination that a challenging agent has falsified the claim, the campaign is terminated and seed bounty points plus any accumulated challenge points are allocated to the asserting agent and all contributed sponsorship bounty points are allocated back to the contributing sponsoring agents. Other embodiments of the present invention could allocate an additional percentage of sponsor bounty points to the asserting agent, or some other allocation scheme which serves to incentivize the participating agents.

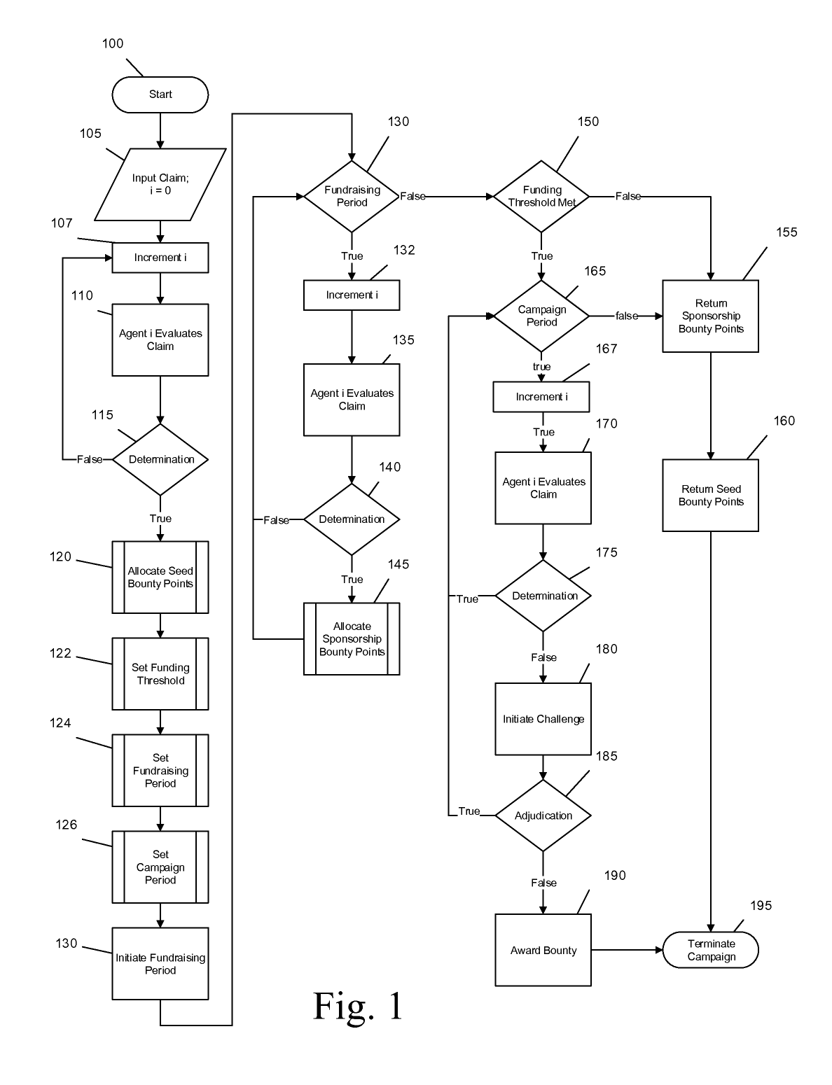

FIG. 1 illustrates an exemplary method by which autonomous software agents in a multi-agent system cooperate and compete to vet the validity of public assertions or claims. The system is initiated 100, a claim is input into the system 105, and the variable i is set to 0. The variable i is incremented by an integer 107, and then an agent designated as agentᵢ evaluates the claim 110. Agentᵢ evaluates the claim utilizing its information profile comprising a corpus of information embodied in an intelligent retrieval mechanism such as an expert system, database, or search capability. Agentᵢ makes a determination as to whether the claim is true, false, or indeterminate according to its information profile 115. If agentᵢ determines that the claim is false or is unable to determine whether it is true or false, then the variable i is incremented by an integer 107 and a new agentᵢ evaluates the claim 110 and makes a determination 115. If agentᵢ determines that the claim is true, agentᵢ is designated the asserting agent. The asserting agent will then determine: 1) seed bounty points 120, being the number of bounty points the asserting agent is contributing to the campaign bounty; 2) funding threshold 122, being the number of bounty points in addition to the seed bounty points that will be sought from other agents to contribute to the campaign bounty as sponsor bounty points; 3) fundraising period 124, being the period of time during which agents will be allowed to contribute sponsor bounty points to the campaign to reach the funding threshold; and 4) campaign period 126, being the period of time during which agents will be allowed to challenge the claim.

The fundraising period then begins 130 for the period set by agentᵢ 124. If the fundraising period is still active 130, then the variable i is incremented by an integer 132 and the new agentᵢ evaluates the claim 135. Agentᵢ makes a determination as to whether the claim is true, false, or indeterminate according to its information profile 140. If agentᵢ makes a determination that the claim is indeterminate, then agentᵢ becomes a neutral agent and no longer interacts with the campaign. If agentᵢ determines that a statement is false, then agentᵢ becomes an opposing agent. In the case of either an indeterminate or false determination 140, if the fundraising period is still active 130, then the variable i is incremented by an integer 132 and the new agentᵢ evaluates the claim 135. If agentᵢ determines that the claim is true 140, then agentᵢ allocates sponsorship bounty points 140 to the campaign bounty. If the fundraising period is still active 130, then the variable i is incremented by an integer 132 and the new agentᵢ evaluates the claim 135.

Continuing with FIG. 1, if the fundraising period 130 has ended, the system will determine if the funding threshold is not met 150. If the funding threshold is not met 150, all contributed sponsorship bounty points will be allocated back to the contributing sponsorship agents 155 and all seed bounty points will be allocated back to the asserting agent 160. The system determination of the claim will then be retired as indeterminate and the campaign will be terminated 195.

If the system determines that the funding threshold is met 150, the campaign will be considered active and will proceed to the campaign period 165 and the variable i is incremented by an integer 167 and the new agentᵢ evaluates the claim 170. Agentᵢ makes a determination as to whether the claim is true, false, or indeterminate according to its information profile 175. If agentᵢ makes a determination that the claim is indeterminate, agentᵢ becomes a neutral agent and no longer interacts with the campaign. If agentᵢ determines that a statement is true, agentᵢ becomes a supporting agent. In one embodiment of the invention, a supporting agent can contribute a support point to the campaign. In another embodiment of the invention, a supporting agent can contribute sponsor bounty points to the campaign. In the case of either an indeterminate or true determination 175, if the campaign period is still active 165, the variable i is incremented by an integer 167 and the new agentᵢ evaluates the claim 170. If the campaign period 165 is not active, all contributed sponsorship bounty points will be allocated back to the contributing sponsorship agents 155 and all seed bounty points will be allocated back to the asserting agent 160. The system determination of the claim will then be retired as indeterminate and the campaign will be terminated 195.

Continuing with FIG. 1, if agentᵢ determines that the claim is false 175, agentᵢ becomes a challenging agent and initiates a challenge 180. In one embodiment of the invention, the challenging agent allocates challenge points to the campaign bounty. Once a challenge has been initiated, the system adjudicates the challenge 180. The adjudication is conducted by an adjudication component, which in one embodiment may an adjudication agent with an information profile. In another embodiment of the invention, the adjudication component may comprise multiple adjudication agents with different classes of information profiles.

If the adjudication component determines 185 that the challenging agent has not falsified the claim, the system determines if the campaign period is still active 165. If the campaign period 165 is not active, all contributed sponsorship bounty points will be allocated back to the contributing sponsorship agents 155 and all seed bounty points will be allocated back to the asserting agent 160. The system determination of the claim will then be retired as indeterminate and the campaign will be terminated 195. If the campaign period 165 is active, the variable i is incremented by an integer 167 and the new agentᵢ evaluates the claim 170.

If the adjudication component determines 185 that the challenging agent has falsified the claim, the campaign bounty is awarded 190 to the challenging agent and the campaign is terminated 195.

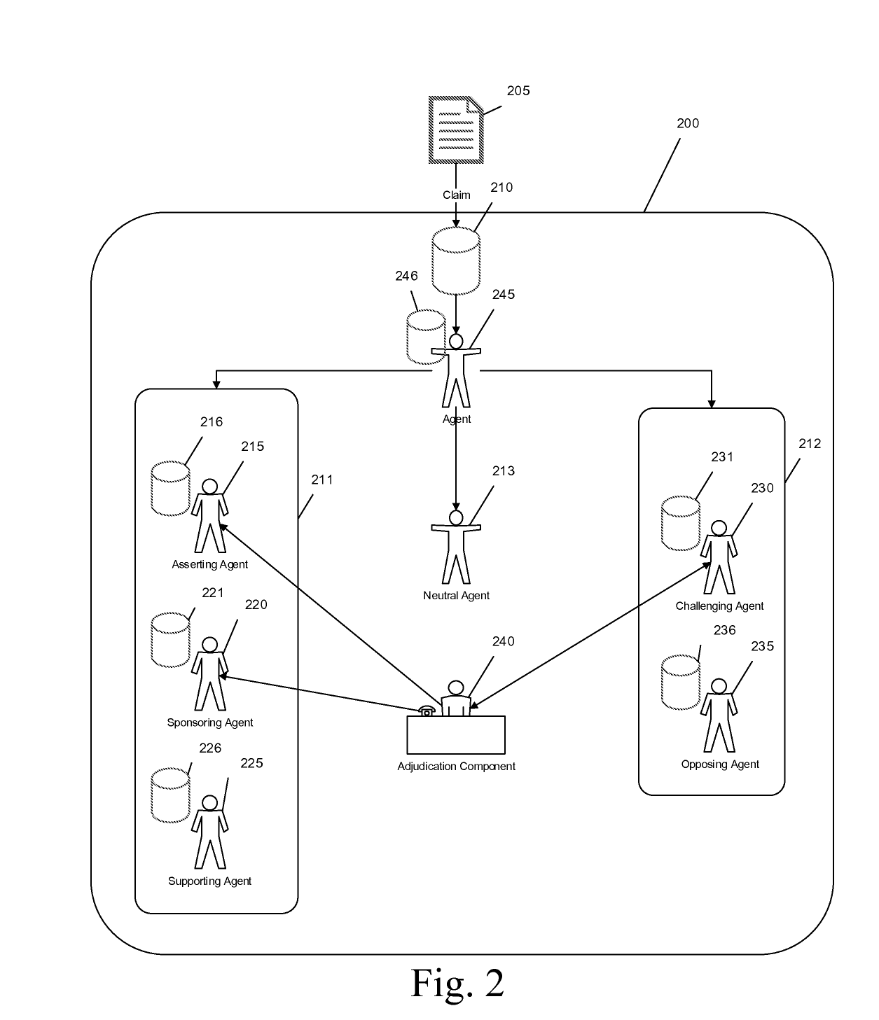

Turing now to FIG. 2, a system for promoting truth in public discourse 200 is depicted comprising a datastore 210, an adjudication component 240 and a plurality of agents 245. When a claim 205 is introduced into the system, it is held in the datastore 210. It should be understood that the datastore could comprise a relational database, an object oriented database, a flat file database, a text file, or any method of storing data on storage media or in random access memory. The claim 205 is then available for analysis by the plurality of agents 245, each of which has a unique information profile 246. In one embodiment of the invention, the plurality of agents are instantiated in memory and each agent 245 analyzes the claim 205 in the order in which it was instantiated. In another embodiment, the agents 245 analyze the claim 205 in random order. In another embodiment, the agents 245 analyze the claim 205 in order based on information contained in its information profile 246. In another embodiment, the agents 245 access metadata associated with the claim 205 and make a determination whether to analyze the claim based on information contained in its information profile 246 and the importance of other operations the agent 245 is processing.

Once an agent 245 has analyzed the claim 210, it will fall into one of three categories based on its determination. If an agent 245 determines that the claim 205 is true, the agent becomes one of the agents depicted in the supporting group 211. If an agent 245 determines that the claim is false, the agent becomes one of the agents depicted in the opposing group 212. If an agent is unable to determine whether the claim is true or false, the agent becomes a neutral agent 213 and no longer participates in the campaign.

Continuing with FIG. 2, the supporting group 211 comprises an asserting agent 215, one or more sponsoring agents 220, and optionally one or more supporting agents 225. When an agent 245 determines that a claim 210 is true, whether it becomes an asserting agent 215, sponsoring agent 220, or supporting agent 225 will depend on the order in which the agent 245 made the determination and the state of the system. If an agent 245 is the first to make a determination that the claim 210 is true, that agent will become the asserting agent 215. The asserting agent 215 will allocate bounty seed points to the campaign bounty based on its information profile 216 and will initiate the fundraising period. If an agent 245 makes a determination that the claim 210 is true during the fundraising period, that agent will become a sponsoring agent 220 and will allocate sponsor bounty points to the campaign bounty based upon its 220 information profile 221. If an agent 245 makes a determination that the claim 210 is true after the fundraising period and during the campaign period, that agent will become a supporting agent 225 and will allocate a support point. In another embodiment, the supporting agent 225 will allocate sponsor bounty points to the campaign bounty based upon its information profile 226.

The opposing group 212 comprises one or more challenging agents 230, and optionally one or more opposing agents 235. When an agent 245 determines that a claim 210 is false, it will become a challenging agent 230 and will initiate a challenge that will be adjudicated by the adjudication component 240. The adjudication component may itself comprise one or more adjudication agents with separate and unique information profiles. The adjudication component 240 will determine whether the challenging agent 230 has provided sufficient information from its information profile 231 to falsify the claim 210. If the adjudication component determines that the challenging agent 230 has falsified the claim 210, the adjudication component will allocate the campaign bounty to the challenging agent 230. If the adjudication component determines that the challenging agent 230 has not falsified the claim 210, the adjudication component will determine if the campaign period is still active, in which case the adjudication component will adjudicate the next challenge in the queue; if the campaign period has expired, all contributed sponsorship bounty points will be allocated back to the contributing sponsoring agents 220 and all seed bounty points will be allocated back to the asserting agent 215. The system determination of the claim will then be retired as indeterminate and the campaign will be terminated.

Continuing with FIG. 2, in one embodiment of the invention, if an agent 245 determines that the claim 210 is false, but the confidence factor is insufficient to warrant the agent 245 allocating challenge points to the campaign bounty, the agent 245 can become an opposing agent 235 accessing information profile 236 and register its opposition by allocating an opposition point to the campaign bounty.

### Distributed System

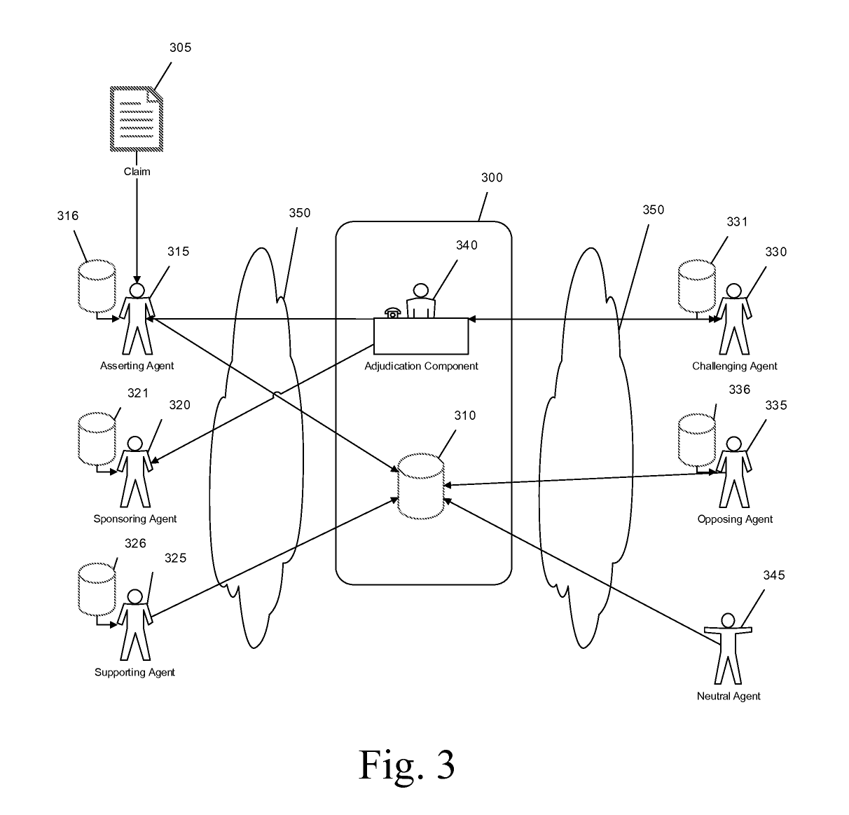

It will be appreciated that the multi-agent system depicted in FIG. 2 can be implemented in a distributed system in which the various agents are not implemented as software agents accessing codified information profiles, but are individuals accessing information based on their own knowledge and information accessing abilities. Such a system is shown in FIG. 3, in which a system for promoting truth in public discourse 300 is depicted comprising a datastore 310, an adjudication component 340, with a plurality of agents distributed externally and communicatively connected to the system through a network 350.

Continuing with FIG. 3, in a distributed system, an asserting agent 315 is a user with an information profile 316 comprising that individual corpus of information and experience who encounters a claim 305 in public discourse, and desires to publicize its veracity by posting a bounty to anyone who can falsify the claim 305. An another embodiment, the distributed system can also handle the opposite case, where an asserting agent 315 is a user who encounters a claim 305 in public discourse, and desires to publicize its falsity by posting a bounty to anyone who can substantiate the claim 305.

The asserting agent 315 submits the claim 305 to the system 300 via the network 350. The claim 305 is stored in the datastore 310. In one embodiment of the invention, the system comprises a front-end website and a back-end database 310; the asserting agent 315 accesses the system 300 over the internet 350 through an http/https connection and submits the claim 305, which is stored in the datastore 301. The asserting agent 315 initiates a campaign by posting the seed bounty points. The asserting agent may also determine campaign parameters such as bounty goal and the fundraising period. Whereas the software agents depicted in FIG. 2 were motivated by points, it will be appreciated that individuals are primarily motivated by money, and seed bounty points, sponsor bounty points and campaign bounty can be denominated in currency in the distributed system. In other embodiments, the points may represent anything of value, including motivational points, rankings, and the like. The system 300 publicly displays the claim 305 and the parameters of the campaign via the front-end website.

If a user accesses the website and views the campaign during the fundraising period, the user may become a sponsoring agent 320 by accessing its information profile 321 and making a determination that the claim is true. A sponsoring agent 320 will allocate sponsor bounty points to the campaign bounty based upon its information profile 321. If a user makes a determination that the claim 305 is true after the fundraising period and during the campaign period, that user may become a supporting agent 325. The supporting agent 325, based on the determination made by accessing its information profile 326 and determining that the claim 305 is true, allocates a support point to the campaign. In another embodiment of the invention, the supporting agent 325 adds an additional amount to the bounty if it determines that the claim 305 if true.

If a user determines that a claim 305 is false, the user may become a challenging agent 330 and will initiate a challenge that will be adjudicated by the adjudication component 340. The adjudication component may itself comprise one or more adjudication agents with separate and unique information profiles. The adjudication component 340 will determine whether the challenging agent 330 has provided sufficient information from its information profile 331 to falsify the claim 305. If the adjudication component determines that the challenging agent 330 has falsified the claim 305, the adjudication component will allocate the campaign bounty to the challenging agent 330. If the adjudication component determines that the challenging agent 330 has not falsified the claim 305, the adjudication component will determine if the campaign period is still active, in which case the adjudication component will adjudicate the next challenge in the queue; if the campaign period has expired, all contributed sponsorship bounty points will be allocated back to the contributing sponsoring agents 320 and all seed bounty points will be allocated back to the asserting agent 315. The system determination of the claim will then be retired as indeterminate and the campaign will be terminated.

Continuing with FIG. 3, in one embodiment of the invention, if a user determines that the claim 305 is false, but the confidence factor is insufficient to warrant the agent user allocating challenge points to the campaign bounty, the user can become an opposing agent 335 accessing information profile 336 and register its opposition by allocating an opposition point to the campaign bounty in form of a comment, or in another embodiment, a claim against the bounty.

### Campaign Creation

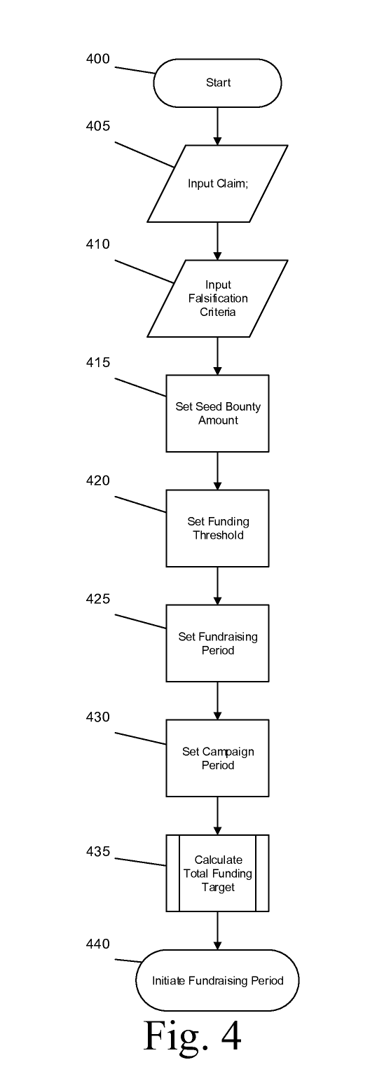

Turing now to FIG. 4, in one embodiment of the present invention, campaigns are created by an asserting agent who accesses a web interface to the system, selects options, provides required elements, agrees to terms of service, and submits an application fee. In order to create a campaign 400, the user inputs the claim 405 into the system, as well as inputting the falsification criteria 410 that will be required to falsify the claim. The data required to create a campaign may also include such items as: 1) A campaign type: BS or TS (BS it means the Asserting Agent considers the claim obviously false; TS means the Asserting Agent considers the claim obviously true); 2) campaign image or video illustrating the best example of the BS claim being asserted or the TS claim being denied); 3) a personal video appeal promoting their campaign and asking for support; 4) campaign headline; 5) campaign tagline; 6) campaign summary paragraph; 7) category (e.g.; from drop down list); 8) tags to be associated with the campaign when it goes live; 9) a (BS) or (TS) claim; 10) a rationale for the campaign (why it's appropriate and what good it should achieve); and 11) evidence or observations supporting the rationale, e.g., a URL illustrating how the TS claim is being denied or how the BS claim is being promoted, or a URL illustrating the truth of the TS claim or the falsity of the BS claim.

Continuing with FIG. 4, in one embodiment of the invention, the user sets the seed bounty amount 415 that is the amount that the user desires to contribute to the total bounty. The use also sets the funding threshold 420 which is the total bounty desired to be paid to a successful challenging agent. In one embodiment of the invention, the user sets the fundraising period 425 that is the number of days during which funds are sought for the campaign. The user may also set the campaign period 430, which is the period of time which the campaign will be active, during which challenging agents can make challenges, and after which the campaign will be terminated. After all of the information has been received from the asserting agent, the system will calculate the total funding target 435, and then initiate the fundraising period 440.

In one embodiment of the present invention, the asserting agent elects various campaign element options and amounts of money for each element. The elements may include: 1) published advertising; 2) online marketing; 3) print advertising; 4) custom video; 5) social media advertising; and 6) press releases. In one embodiment of the present invention, before submitting the proposed campaign application, the asserting agent specifies which options to include and either a single value (the minimum for that option) or a range of values representing their minimum and their maximum for each option. The system uses these option amounts to calculate a total cost for the campaign (or one minimum and another maximum), which represent the range that fundraising is targeting. The total funding target is computed as the amount of money before financing charges needed to cover all of the selected campaign options plus any service fees that apply to any of those options. There's always a minimum funding target, because there are always elements included with minimal amounts. There may be cases where the campaign includes a range for some option, such as a minimum and a maximum bounty. When a maximum goal that is different than the minimum goal has been selected, both a minimum total fundraising target and a maximum total fundraising target are calculated using the equation above. Fundraising in that case would need to meet the minimum goal and could continue until the maximum goal is achieved or some number less than that is reached when the campaign fundraising duration expires. When an amount is raised between the minimum goal and maximum goal, it is apportioned to each campaign element appropriately. The elements that only specify a minimum goal get that amount. All other elements get the same percentage of the way from their min to their max goals as uses up all the money available above the minimum fundraising target after subtracting applicable fees.

In one embodiment of the invention, the service fee is a sliding percentage based on the size of the bounty. For example, a $1000 bounty may have a $1000 fee, which is 100% of bounty; a $5,000 bounty may have a $2500 fee, which is 50% of bounty; and a $10,000 bounty may have a $3750 fee, which is 37.5% of bounty. If any campaign elements specify a maximum amount, the target maximum total is computed in a similar way. The system then: 1) computes the service fee for the maximum bounty amount; 2) computes the subtotal as the sum of the service fee for the maximum bounty amount plus the maximum amounts of all the other campaign options; 3) divides the subtotal by (1—payment handling fees, if any) to give you the total, maximum fundraising target. The payment handling fees for credit card transactions average about 5%, so that step 3 assures that the money available for campaign costs after payment handling fees are sufficient to cover the actual (net) campaign costs. In one embodiment of the invention, the determined total fundraising targets are shown to the asserting agent, as is the breakdown of how they were computed. The asserting agent can adjust the option amounts until satisfied and then include them as part of the campaign application. The asserting agent does not pay for the campaign application until ready to submit it for vetting. Projects may require an application fee.

In one embodiment of the present invention, the asserting agent clicks “Start a Campaign” on the home page; the asserting agent is forced to login and if registering for the first time is required to check they accept the terms of use. They are asked whether they want to initiate a BS campaign or a TS campaign.

The BS campaign is appropriate if the asserting agent is trying to fight against repeated bogus claims, where some people are intentionally misleading others by spreading untruths. The asserting agent frames the bogus claim in a few words, identifies the source or speaker who exemplifies this kind of objectionable behavior. The asserting agent may also provide a video clip, image, or text source illustrating the source/speaker making the bogus claim.

The TS campaign is appropriate if the asserting agent is trying to fight against repeated denials of an obviously true claim, where some people are intentionally misleading others by denying the truth of the claim. The asserting agent frames the true and wrongly denied claim in a few words and identifies the source or speaker who exemplifies this kind of objectionable behavior. The asserting agent may also provide a video clip, image, or text source illustrating the source/speaker making the bogus claim.

### Vetting

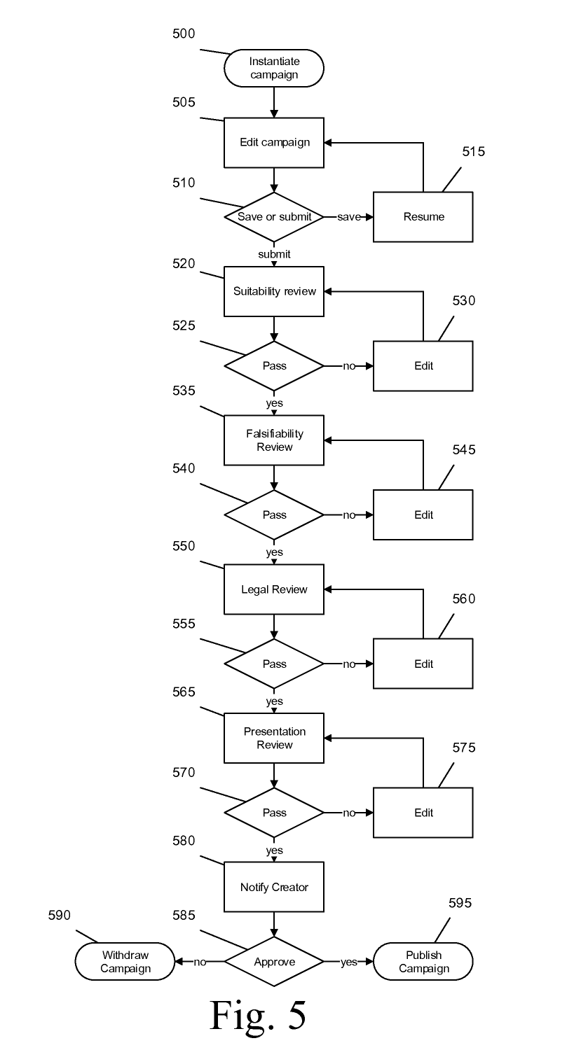

Once the asserting agent has submitted the data, the campaign may be vetted before it is posted for fundraising. Turning now to FIG. 5, a method is shown for instantiating a campaign 500 and vetting it prior to publication. After the asserting agent has submitted the necessary data for the campaign, the asserting agent is given the opportunity to edit the campaign data 505, upon which the asserting agent may edit and then save or submit 510. If the asserting agent saves the data, the asserting agent may resume 515 and further edit campaign data 510. If the asserting agent submits the campaign data, the system will conduct a suitability review 520. The system will determine if the campaign passes suitability review 520. If the campaign does not pass suitability review, the system will edit 530 the submitted campaign application and then re-submit 520 it for approval 525. In one embodiment of the invention, a staff member with edit privileges edits the campaign. Criteria for the suitability review may include: 1) campaign must be aimed at making the public better informed about some statement; e.g., make them more aware of and more accepting of facts; e.g., Less susceptible to and less believing of falsehoods and unsubstantiated claims; 2) the subject claim must concern something of importance or value to the public; 3) the claim must be testable or observable in principle; and 4) there must be some evidence that statement matters to the public and that the public's understanding is threatened by manipulators, liars or deniers. Additional criteria for the suitability review may include: 1) must not be motivated primarily by an interest in disparaging a person; 2) must not be malicious, slanderous, defamatory; 3) must not be fabricated for the primary purpose of deceiving or misleading people; and 4) must not include pornography or depictions of cruelty unless vitally important for helping inform the public about efforts to mislead, manipulate or deceive them.

Continuing with FIG. 5, in one embodiment of the present invention, [0071] the campaign is then reviewed for falsifiability 535 in which the system assures that the description of the data needed to falsify the campaign is clear. If the campaign does not pass falsifiability review, the system will edit 545 the submitted campaign application and then re-submit 535 it for approval 540. In one embodiment of the invention, a staff member with edit privileges edits the campaign. Criteria for the falsifiability review may include: 1) the claim labeled BS or TS must be testable or observable in principle; 2) an experiment or test to produce falsifying (incompatible) data must be imaginable; and 3) it should be possible to describe results of that experiment or test in advance that would be sufficient to reject the statement or its negative.

Continuing with FIG. 5, in one embodiment of the present invention, [0073] the campaign is then reviewed for legality 550 in which the system assures that the campaign complies with all legal requirements. If the campaign does not pass legal review 550, the system will edit 560 the submitted campaign application and then re-submit 550 it for approval 555. In one embodiment of the invention, a lawyer with edit privileges edits the campaign. Criteria for the legal review may include: 1) must not be malicious, slanderous, or defamatory; and 2) must not include copyrighted material unless a standard of fair use is achieved.

Continuing with FIG. 5, [0075] in one embodiment of the present invention, the campaign is then reviewed for presentabilty 565 in which the system assures that the campaign is suitable for display. If the campaign does not pass presentability review 570, the system will edit 575 the submitted campaign application and then re-submit 565 it for approval 570. In one embodiment of the invention, a staff member with edit privileges edits the campaign. Criteria for the presentation review may include: 1) campaign should render attractively on browsers and mobile devices; and 2) text should be clear, concise and free of apparent errors.

Continuing with FIG. 5, once the various reviews have been completed, the asserting agent is given the opportunity to approve or decline the reviewed campaign 585 in which changes or edit may have been made in the course of such reviews. If the asserting agent does not approve 585, then the campaign is withdrawn 590. If the asserting agent approves 585, then the campaign is published 595 and enters the fundraising phase. In some embodiments of the invention, campaign applications that do not surpass review criteria are rejected by the system as unacceptable rather than edited and resubmitted.

### Fundraising and Sponsorship

Once campaign applications are vetted, approved, and published, fundraising begins. Funding continues until the goals are met or the fundraising period expires. Sponsoring agents contribute to the campaign bounty during the fundraising period. In one embodiment, sponsoring agents can add comments and upload evidence to support the campaign. Evidence may include a URL or a file and some text explaining how/why the evidence supports the campaign's position. In one embodiment of the invention, comments and evidence become discussion threads with subordinate comments and evidence and allows others to rate comments and evidence as + (up, postive) or − (down, negative), such that people can browse evidence sorted by appropriate criteria and filters (usually highest overall rating is presented first). Campaigns that have only a specific funding threshold (a minimum required) can begin when that threshold is reached. Campaigns that have a min and a maximum funding threshold stop fundraising efforts when the max threshold is reached or when the fundraising deadline is reached. When the fundraising deadline is reached, campaigns below minimum threshold are rejected for insufficient fundraising

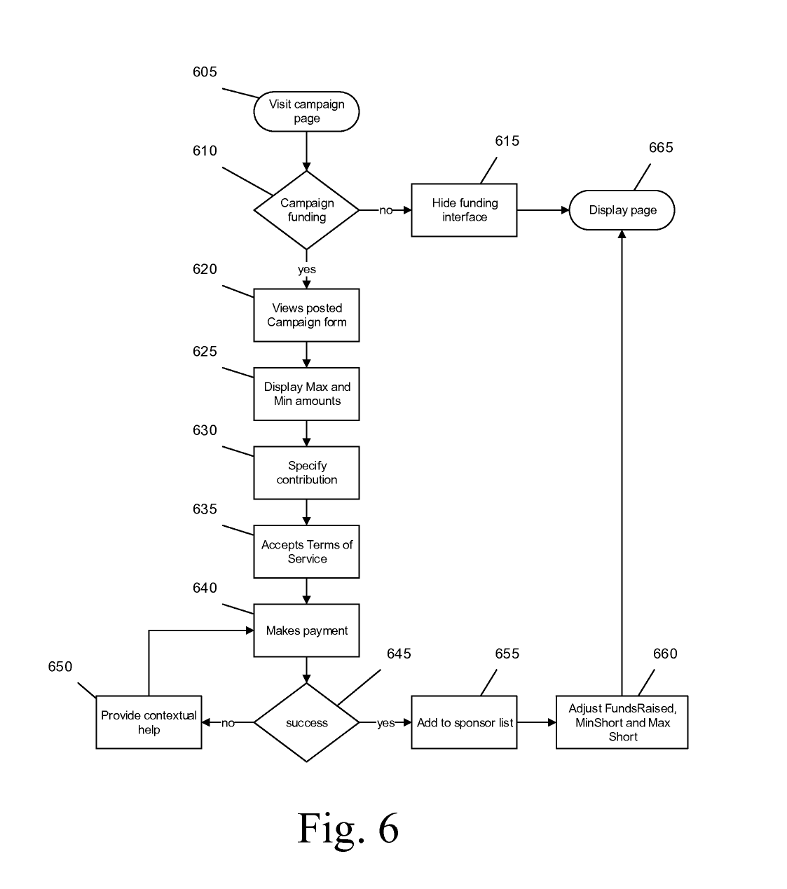

Turning now to FIG. 6, a sponsoring agent accesses the campaign page 605 on a website. If the fundraising period has expired 610, the funding interface is hidden 615 and the campaign page is displayed 665. If the fundraising period has not expired 610, the funding interface is exposed and the sponsoring agent view the posted campaign form 620. This takes the sponsoring agent to the page where it can view the campaign, campaign elements, and potentially a personal video appeal from the asserting agent. The sponsoring agent is shown the maximum and minimum amounts 625 enabling the sponsoring agent to determine how much to contribute to the bounty. In one embodiment, the sponsoring agent clicks on a button to SPONSOR the campaign and accesses a page wherein the sponsoring agent can specify the contribution 630 to be made to the bounty. The sponsoring agent then signifies acceptance to the terms of service 635 and submits payment 640. If payment is unsuccessful 645, contextual help is provided 650 to the sponsoring agent and it is given the opportunity to re-submit payment 640. If payment is successful 645, the sponsoring agent is added to the list of sponsoring agents 655 for the campaign, and the system adjusts the financial records tracking the funds raised for the bounty 660, as well as applicable minimum and maximum deltas, and the campaign page is displayed 665 with the funding interface hidden.

### Challenging Campaigns

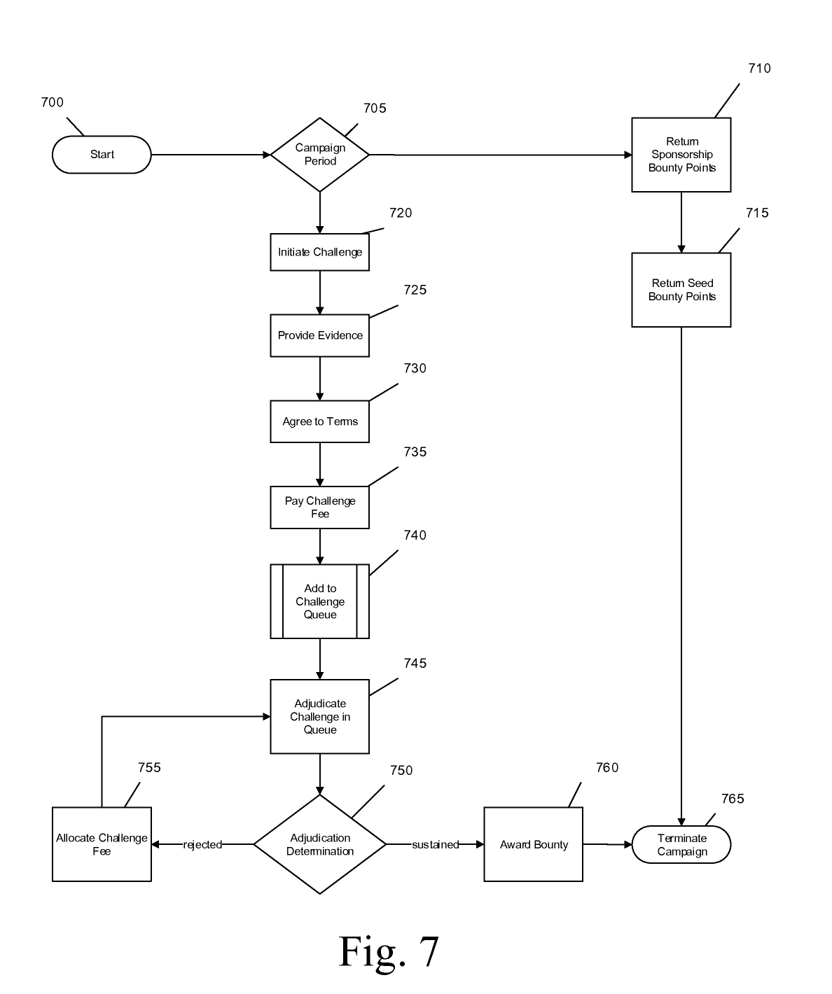

FIG. 7 illustrates the method for challenging a campaign. Once the campaign has been published, challenging agents may challenge it. In one embodiment of the present invention, campaigns can be challenged 700 during the campaign period 705 when a challenging agent initiates a campaign 720, answers checklist questions, submits evidence 725, agrees to terms of service 730, and submits a challenge fee 735. Multiple challenges can be accepted, and each is given a sequential number that determines the order in which they are subsequently processed 740. Challenges are considered in order received 745, until one is sustained 750 (evaluated as correct, “upheld”) or until the campaign terminates 765 for some other reason. Challenging agents whose challenges are sustained 750 win the bounty 760. Challenging agents whose challenges are rejected are notified and lose their challenge fee 755, and the adjudication component adjudicates the next challenge in the queue 745. In one embodiment of the invention, the evaluation of a challenge is recorded and becomes part of the visible challenge record. Once the campaign terminates, any challenges still unprocessed awaiting evaluation are closed out with the challengers receiving their challenge fees back. If the campaign period expires 705 without a successful challenge, the contributions made by sponsoring agents are returned 710 and the contribution made by the asserting agent is returned 715 and the campaign is terminated 765. In other embodiments of the invention, service fees or a percentage of some combination of the asserting agent contribution and sponsoring agent contribution may be retained by the system. In one embodiment of the present invention, a percentage of the sponsoring agents' contributions may be allocated to the asserting agent.

In one embodiment of the present invention, each challenge must purport to falsify the campaign assertion. If the campaign is that claim C is BS, the challenge must show that C is not BS, i.e. that CS is true. If the campaign is that claim C is TS, the challenge must show that C is not TS, i.e. that C is false. The challenging agent agrees that for a statement for a BS or TS campaign: 1) (*C is BS) challenging agent is aware of credible and appropriate data that disconfirm the campaign, which prove the claim is true; 2) (*C is TS) challenging agent is aware of credible and appropriate data that disconfirm the campaign, which prove the claim is false. The challenging agent documents the disconfirming data, including any number of data sources. For each data source, challenging agent may be required to provide elements such as: a) a description of the data; b) a file containing the data (.xls, .csv, .doc, .txt, or .pdf formats); c). a file describing how to read, decipher and interpret the data in b.; d) an article or document describing the experiment that produced the data, including who conducted it, how it was done, and any biases or conflicts of interest of the investigators.; e) any URL that points to additional analysis pertinent to accepting these data and interpretation; and/or f) a concise statement explaining how or why the data disconfirm the claim.

In one embodiment of the present invention, the system will accept and queue challenges in a first-come, first-served (FIFO) order. Any challenges remaining in the queue after a successful challenge will be purged and challenge fees returned. In another embodiment of the present invention, the system allows asserting agents to offer multiple bounties for multiple but distinct challenges in cases where the asserting agent is seeking multiple distinct kinds of evidence. In the process of initiating a challenge, challenging agents submit a non-refundable challenge fee. For example: a $1000 bounty may have a $75 challenge fee (7.5%); a $5000 bounty may have a $250 challenge fee (5%); etc.

In one embodiment of the present invention, if required, the adjudication component may request more data from the challenging agent. In one embodiment of the invention, the written decision and the rejection or confirmation becomes part of the public record. In one embodiment of the invention, the submitted data/evidence becomes part of the public record.

In one embodiment of the invention, participants develop reputations and ratings based on the roles they have played in various campaigns and how the campaigns ended. Asserting agents who submit campaign applications develop a reputation based on how many of their campaigns are funded and successful (unfalsified) vs. how many are funded and falsified. Participants might have multiple histories and reputations. The basic rating is zero to five stars, computed as the number of “successful” campaigns minus the number of “falsified” campaigns. Sponsoring agents develop a sponsor batting average, which is the ratio of the number of dollars they have given to successful campaigns divided by the total number of dollars they have given to all campaigns, presented as a fixed 3-digit decimal from 0.000 (the worst) to 1.000 the best. These are like baseball “batting averages”. Challenging agents develop reputations based on the number of challenges they made that were sustained minus the number they made that were rejected (zero to five max).

In one embodiment of the present invention, methods are provided such that the adjudication component receives a notice that there is a challenge to one of the campaigns; if there are multiple challenges, the adjudication component will assess the earliest one not yet evaluated; the adjudication component assesses the data in light of a check list for how to perform an evaluation; the adjudication component processes the data and the checklist and records the results; this may take hours or days, and may involve out-sourced work or even a jury of experts; eventually a decision is reached and written; the decision is recorded and the challenging agent is notified. If the challenge is rejected, the challenging agent is notified that the challenge has been rejected; the challenging agent's reputation for sustained challenges is reduced (number of rejected challenges increased); if there is another challenge waiting for this campaign, a message is sent to the appropriate reviewers that a new challenge is awaiting processing. If the challenge is sustained, the challenging agent is notified that the challenge has been affirmed (upheld, sustained). The bounty amount is credited to the challenging agent's account and debited from the master account balance. If there is another challenge waiting for this campaign, that challenge is refused and that challenging agent receives back his challenge fee along with a message stating that an earlier challenge was successful. The asserting agent is notified. The campaign status is changed to Falsified. The campaign is no longer active. The challenging agent's reputation for sustained challenges is increased.

In one embodiment of the present invention, a method is provided to terminate a successful (unfalsified) campaign. The relevant parties are notified that the expiration date of the live campaign has passed, the campaign status is changed to Successful, and the campaign is no longer active. In one embodiment of the present invention, a reward of 20% of bounty is credited to the asserting agent's account, debited from the master account, and the asserting agent is notified. The balance of 80% of bounty is paid out to sponsoring agents in proportion to their contributions for the total raised. The money is credited to the sponsoring agent's account and debited from the master account, and the sponsoring agent is notified. The history of the asserting agent is updated to reflect that this campaign ended successfully, which improves the asserting agent's reputation. The sponsorship histories for each sponsoring agent are updated to reflect that their contribution to this campaign are counted towards the numerator of their sponsorship success batting averages. Because the campaign is now inactive, it no longer appears on the list of current campaigns.

### Structure of Exemplary Website

In one embodiment of the present invention, the presentation layer may be developed using CSS, HTML, Javascript, and php. The data layers can be provided using a relational database such as MySQL, SQL Server, Oracle, and the like. The middleware could be developed using Java & Play Framework for object oriented MVC programs, generating or consistent with the MySQL database schema. The exemplary website could be developed with an open source repository and configuration management system; a test management environment consisting of use cases employed for unit, functional and user interface testing, a means of automating or recording test results, a summary report of test results, and a report of which parts of the system have not been tested.

In one embodiment of the present invention, the system provides an easy interface for campaign creators and sponsors to promote their campaigns by posting references to their campaigns in those other environments. In one embodiment, a button or badge could be employed with an associated logo to identify a campaign seeking funding, which could also be transmitted automatically to social networks such as Facebook and Twitter by the asserting agent or sponsoring agent. Messages on status changes could be sent to the asserting agent and sponsoring agents and these would be easy for them to post on Facebook or Twitter. People who are active in social media such as Facebook, Twitter, Google, Linkedln and the like are able to register with web interface using those other credentials and seamlessly share information between those environments and the campaigns they wish to associate with them.

In one embodiment of the present invention, a Model-View-Controller architecture is used is which controllers provide most of the functions needed to create, find, display, and update model instances. In one embodiment of the present invention, methods are provided to cover 1) the financial transactions associated with the campaigns; 2) the user login/registration and credential use; 3) the sharing capabilities; and 4) the initial user identities, profiles, histories and accounts. In one embodiment of the present invention, the presentation layers include a Home page, a Site Map, a Search box, an About Us page, and Discover Campaigns (and campaign search) pages. The embodiment could provide mechanisms for payment to support equivalent functionality in a separately developed mobile application.

In one embodiment of the present invention, methods are provided for viewing active campaigns, sponsoring campaigns that are published for fundraising, creating campaigns, vetting and reviewing campaigns, and publishing campaigns for fundraising. In one embodiment of the present invention, methods are provided for terminating fundraising, notifying a user whose campaign is underfunded (didn't reach threshold), returning funding to sponsors, publishing campaigns as funded and live, computing bounty amounts, activating challenges, computing other amounts available net of fees, and notifying campaign executors of each component and funding levels for execution. In one embodiment of the present invention, methods are provided for completing user profiles, histories, and reputations; completing financial transaction histories and administrative controls; accepting a challenge applications, giving them serial numbers, and queuing them; and notifying a challenge reviewer when there is a challenge ready for review. In one embodiment of the present invention, methods are provided for implementing a challenge review process; publishing results that should be public; if the challenge is successful, implementing the bounty payment transaction, notifying the challenger, notifying the creator, changing the campaign status to falsified, changing the challenge status to sustained, updating history, reputations, and records. If the challenge is unsuccessful, methods are provided for notifying the challenger and creator; marking the challenge rejected, updating history, reputations, and records. Next challenge in queue is then considered. If the campaign duration expires, all pending challenges are returned as “too late” to consider

In one embodiment of the present invention, methods are provided for producing a financial audit of the campaign showing all amounts paid in, all fees charge and incurred, and all amounts paid out, and any balance remaining in each campaign element; determining the gross profit or loss on each campaign element and the overall campaign; providing this as a spreadsheet; and notifying relevant users when this is available. In one embodiment of the present invention, methods are provided for allowing users to login with credentials from other social media sites; providing users with promotional cash for proposing campaigns; and providing promotional cash for getting other users from social networks to register as well.

In one embodiment of the present invention, methods are provided such that any users have identities and they can have different privileges based on membership in different groups; initially each campaign has only one asserting agent, but other embodiments may allow a group of co-creators; each campaign has several sponsoring agents; the sponsoring agents differ based on how much they contribute, which determines their “share” of the campaign; each campaign can have many challenges; each challenge has a single challenging agent; system staff members can have different privileges based on their groups; vetters can review campaign proposals; adjudicators can review challenges; campaign executors can change the status of campaigns; financial administrators can issue or approve debits against the master account; IT administrators can change any part of the system; and all changes to financial accounts are recorded and these are persistent and un-editable.

In one embodiment of the present invention, methods are provided such that users may search for campaigns (discover, returning sortable and filterable lists); search categories and available filters should be available for mobile devices); get returned lists that are re-sortable and filterable by a web service call. Additional methods are provided for creating and maintaining user profiles wherein users can elect to have a pseudonym or public-handle associated with their campaigns; develop a history that follows their roles as asserting agents, challenging agents, or co-sponsoring agents; their Campaign Creator Cred measures their success at creating campaigns; their Challenger Cred measures their success at challenging claims; their Truth Sponsor Batting Average measures their success at sponsoring successful campaigns; their history shows for campaigns they initiated, the number of campaigns that went LIVE (#L), the number of successful campaigns (#TUF), the percentage of successful campaigns (#TUF/#L*100), the number of campaigns that were successfully challenged (#SC), the Campaign Initiation Leadership Level, one to 5 Stars based on Level=#TUF-#SC, Five Stars if Level>=5, Four Stars if Level=4, etc. The rating goes up every time the user creates or co-creates a successful campaign (one that gets funded, and never successfully challenged), the rating goes down when people successfully challenge the users' campaigns, using equal weights, using other evaluation criteria.

In one embodiment of the present invention, there is maintained a list of all past and current campaigns that may be archived and reviewable indefinitely. For campaigns a user supported as co-sponsors, there is the number of co-sponsored campaigns that went LIVE, total $ sponsoring successful campaigns ($S), total $ sponsoring all campaigns ($T), Truth Sponsor Batting Average (TSBA)=$S/$T, Truth Sponsorship Leadership Level, One to Five Stars based on TSBA: Five Stars if TSBA>=0.800, Four Stars if 0.800>Level>=0.600, Three Stars if 0.600>Level>=0.400, Two Stars if 0.400>Level>=0.200, One Star if 0.200>Level>0. Their leadership levels (for campaign creation, claim challenging, and truth support) should have appropriate nice graphic icons that enhance their name/graphic wherever it appears.

In one embodiment of the present invention, each user has an online account or wallet; it can contain promotional cash credits (unexpired, non-zero); these can be used for campaign application submittal fees; it can contain actual dollars; these can be used for any purchase on the site or to request a check to be mailed to their actual address or some other form of electronic payment. Additionally, there is a Master Account which reflects the “money available” within TruthMarket held by the company (that's the Account balance); transactions to/from Personal Accounts and to/from Truth Market bank accounts are posted here; all transactions are recorded, persistent, and secure; payment service fees collected from sponsors are credited and payment service fees paid to banks and payment servers are debited from the Master Account as well.

In another embodiment, the user should be able to sponsor a campaign or pay for a challenge application fee either from his personal account or using any typical payment service; the payment service available on the website should also be compatible with a callable web service by a mobile application.

### Exemplary System Architecture of the Invention

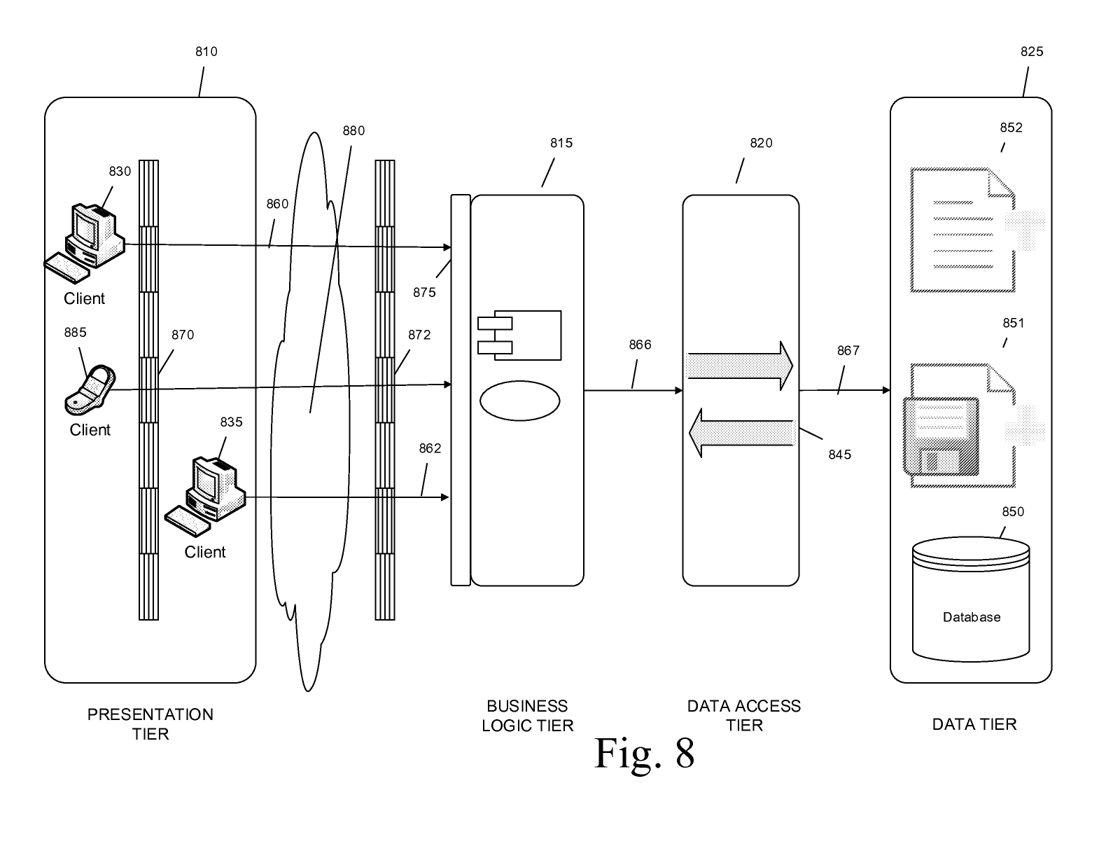

An exemplary system architecture of the invention is described below in connection with FIG. 8. According to an embodiment of the present invention, the system may be comprised at least in part of off-the-shelf software components and industry standard multi-tier (a.k.a. “n-tier”, where “n” refers to the number of tiers) architecture designed for enterprise level usage. One having ordinary skill in the art will appreciate that a multitier architecture includes a user interface, functional process logic (“business rules”), data access and data storage which are developed and maintained as independent modules, most often on separate computers.

According to an embodiment of the present invention, the system architecture of the system comprises a Presentation Logic Tier 810, a Business-Logic Tier 815, a Testing Tier 817, a Data-Access Tier 820, and a Data Tier 825.

The Presentation Logic Tier 810 (sometimes referred to as the “Client Tier”) comprises the layer that provides an interface for an end user (i.e., an Asserting Agent, Sponsoring Agent, Neutral Agent and/or a Challenging Agent) into the application (e.g., session, text input, dialog, and display management). That is, the Presentation Logic Tier 810 works with the results/ output 860, 862 of the Business Logic Tier 815 to handle the transformation of the results/output 860, 862 into something usable and readable by the end user's client machine 830, 835, 885. Optionally, a user may access the using a client machine 830 that is behind a firewall 870, as may be the case in many user environments.

The system uses Web-based user interfaces, which accept input and provide output 860, 862 by generating web pages that are transported via the Internet through an Internet Protocol Network 880 and viewed by the user using a web browser program on the client's machine 830, 835. In one embodiment of the present invention, device-specific presentations are presented to mobile device clients 885 such as smartphones, PDA, and Internet-enabled phones. In one embodiment of the present invention, mobile device clients 855 have an optimized subset of interactions that can be performed with the system, including browsing campaigns, searching campaigns, and sponsoring campaigns. In one embodiment of the invention, mobile device clients 885 can share campaigns on social media, email, or text messaging from the mobile device.

According to an embodiment of the present invention, the Presentation Logic Tier 810 may also include a proxy 875 that is acting on behalf of the end-user's requests 860, 862 to provide access to the Business Logic Tier 815 using a standard distributed-computing messaging protocol (e.g., SOAP, CORBA, RMI, DCOM). The proxy 875 allows for several connections to the Business Logic Tier 815 by distributing the load through several computers. The proxy 875 receives requests 860, 862 from the Internet client machines 830, 835 and generates html using the services provided by the Business Logic Tier 815.

The Business Logic Tier 815 contains one or more software components 840 for business rules, data manipulation, etc., and provides process management services (such as, for example, process development, process enactment, process monitoring, and process resourcing).

In addition, the Business Logic Tier 815 controls transactions and asynchronous queuing to ensure reliable completion of transactions, and provides access to resources based on names instead of locations, and thereby improves scalability and flexibility as system components are added or moved. The Business Logic Tier 815 works in conjunction 866 with the Data Access Tier 820 to manage distributed database integrity. The Business Logic Tier 815 also works in conjunction 864, 865 with the Testing Tier 817 to assess Innovations and examine results.

Optionally, according to an embodiment of the present invention, the Business Logic Tier 815 may be located behind a firewall 872, which is used as a means of keeping critical components of the system secure. That is, the firewall 872 may be used to filter and stop unauthorized information to be sent and received via the Internet-Protocol network 880.

The Data-Access Tier 820 is a reusable interface that contains generic methods 845 to manage the movement 867 of Data 850, Documentation 852, and related files 851 to and from the Data Tier 825. The Data-Access Tier 820 contains no data or business rules, other than some data manipulation/transformation logic to convert raw data files into structured data that Innovations may use for their calculations in the Testing Tier 817.

The Data Tier 825 is the layer that contains the Relational Database Management System (RDBMS) 850 and file system (i.e., Documentation 852, and related files 851) and is only intended to deal with the storage and retrieval of information. The Data Tier 825 provides database management functionality and is dedicated to data and file services that may be optimized without using any proprietary database management system languages. The data management component ensures that the data is consistent throughout the distributed environment through the use of features such as data locking, consistency, and replication. As with the other tiers, this level is separated for added security and reliability.

### Example Computing System

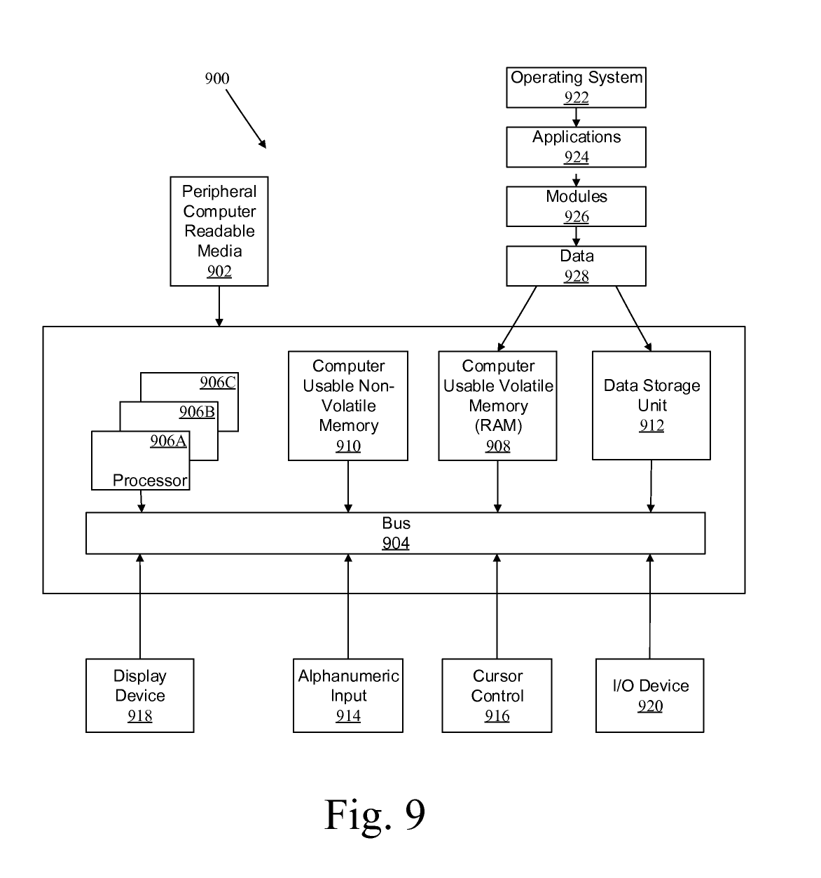

With reference now to FIG. 9, portions of the technology for providing computer-readable and computer-executable instructions that reside, for example, in or on computer-usable media of a computer system. That is, FIG. 9 illustrates one example of a type of computer that can be used to implement one embodiment of the present technology.

Although computer system 900 of FIG. 9 is an example of one embodiment, the present technology is well suited for operation on or with a number of different computer systems including general purpose networked computer systems, embedded computer systems, routers, switches, server devices, user devices, various intermediate devices/artifacts, standalone computer systems, mobile phones, personal data assistants, and the like.

In one embodiment, computer system 900 of FIG. 9 includes peripheral computer readable media 902 such as, for example, a floppy disk, a compact disc, and the like coupled thereto.

Computer system 900 of FIG. 9 also includes an address/data bus 904 for communicating information, and a processor 906A coupled to bus 904 for processing information and instructions. In one embodiment, computer system 900 includes a multi-processor environment in which a plurality of processors 906A, 906B, and 906C are present. Conversely, computer system 900 is also well suited to having a single processor such as, for example, processor 906A. Processors 906A, 906B, and 906C may be any of various types of microprocessors. Computer system 900 also includes data storage features such as a computer usable volatile memory 908, e.g. random access memory (RAM), coupled to bus 904 for storing information and instructions for processors 906A, 906B, and 906C.

Computer system 900 also includes computer usable non-volatile memory 910, e.g. read only memory (ROM), coupled to bus 904 for storing static information and instructions for processors 906A, 906B, and 906C. Also present in computer system 900 is a data storage unit 912 (e.g., a magnetic or optical disk and disk drive) coupled to bus 904 for storing information and instructions. Computer system 900 also includes an optional alpha-numeric input device 914 including alpha-numeric and function keys coupled to bus 904 for communicating information and command selections to processor 906A or processors 906A, 906B, and 906C. Computer system 900 also includes an optional cursor control device 916 coupled to bus 904 for communicating user input information and command selections to processor 906A or processors 906A, 906B, and 906C. In one embodiment, an optional display device 918 is coupled to bus 904 for displaying information.

Referring still to FIG. 9, optional display device 918 of FIG. 9 may be a liquid crystal device, cathode ray tube, plasma display device or other display device suitable for creating graphic images and alphanumeric characters recognizable to a user. Optional cursor control device 916 allows the computer user to dynamically signal the movement of a visible symbol (cursor) on a display screen of display device 918. Implementations of cursor control device 916 include a trackball, mouse, touch pad, joystick or special keys on alphanumeric input device 914 capable of signaling movement of a given direction or manner of displacement. Alternatively, in one embodiment, the cursor can be directed and/or activated via input from alphanumeric input device 914 using special keys and key sequence commands or other means such as, for example, voice commands.

Computer system 900 also includes an I/O device 920 for coupling computer system 900 with external entities. In one embodiment, I/O device 920 is a modem for enabling wired or wireless communications between computer system 900 and an external network such as, but not limited to, the Internet. Referring still to FIG. 9, various other components are depicted for computer system 900. Specifically, when present, an operating system 922, applications 924, modules 926, and data 928 are shown as typically residing in one or some combination of computer usable volatile memory 908, e.g. random access memory (RAM), and data storage unit 912. However, in an alternate embodiment, operating system 922 may be stored in another location such as on a network or on a flash drive. Further, operating system 922 may be accessed from a remote location via, for example, a coupling to the Internet. In one embodiment, the present technology is stored as an application 924 or module 926 in memory locations within RAM 908 and memory areas within data storage unit 912.

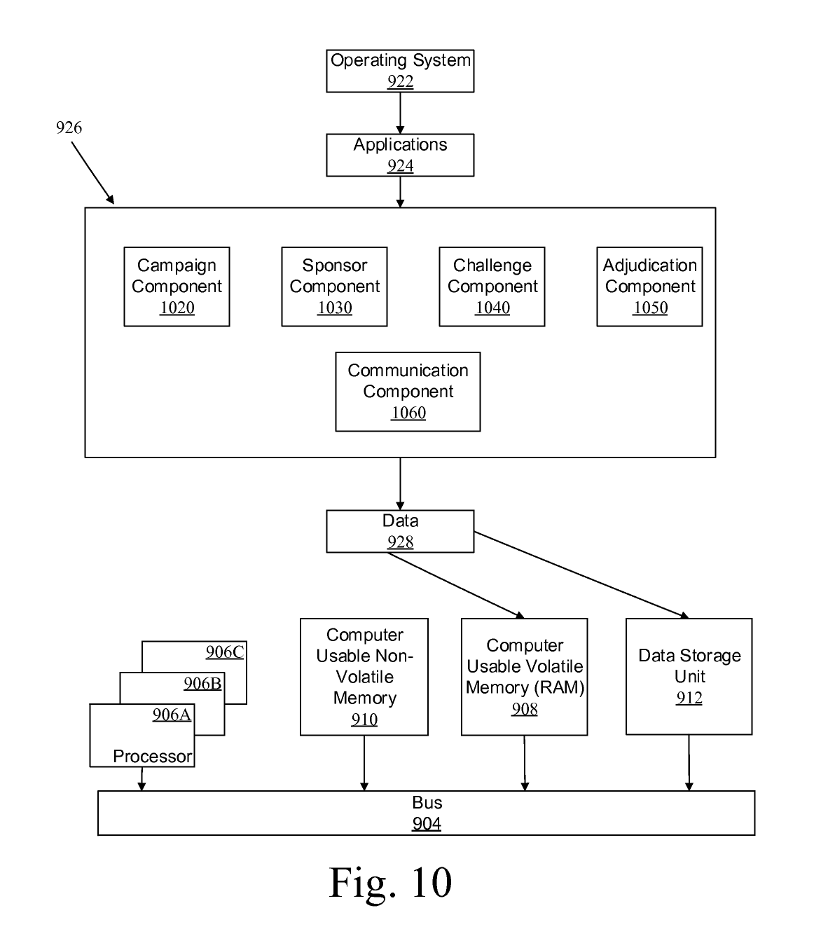

FIG. 10 illustrates the exemplary computing system utilizing specific modules wherein the operating system 922 hosts the application 924 accessing modules 926 manipulating data 928. Modules 926 include campaign component 1020, sponsor component 1030, challenge component 1040, adjudication component 1050, and communication component 1060. Campaign component 1020 is configured to receive campaign information from an asserting agent. Campaign information includes the claim that is to be vetted by the system. In other embodiments of the present invention, campaign information includes parameters such as duration of the fundraising period, duration of the campaign, and allocation of seed bounty points. Sponsor component 1030 is configured to receive sponsor information from a sponsoring agent. Sponsor information includes sponsorship bounty points, or the amount that a particular sponsoring agent is allocating to the bounty. Challenge component 1040 is configured to receive challenge information from a challenging agent. The challenge information includes evidence to falsify the claim. Adjudication component 1040 is configured to evaluate the claim and the challenge information. The evaluation determines if the challenge information falsifies the claim. Data storage unit 912 stores data 928 manipulated by the campaign component 1020, sponsor component 1030, challenge component 1040 and adjudication component 1050 as the campaigns proceed through a workflow processed by the system. Communication component 1060 sends communications to campaign participants as the campaigns proceed through the workflow processed by the system. In one embodiment of the invention, communication component 1060 sends communications to asserting agents when a challenging agent challenges a claim. In one embodiment of the invention, communication component 1060 sends communications to asserting agents and challenging agents with results of adjudication.

The present technology may be described in the general context of computer-executable instructions stored on computer readable medium that may be executed by a computer. However, one embodiment of the present technology may also utilize a distributed computing environment where tasks are performed remotely by devices linked through a communications network.

It is to be understood that the exemplary embodiments are merely illustrative of the invention and that one skilled in the art may devise many variations of the above-described embodiments without departing from the scope of the invention. It is therefore intended that all such variations be included within the scope of the following claims and their equivalents.

What is claimed is:

1. A method for vetting claims, the method comprising:
a. receiving a claim by use of an asserting agent wherein the asserting agent accessing a first corpus of information determines the claim to be true;
b. evaluating the claim by use of a challenging agent accessing a second corpus of information wherein the evaluation determines the claim to be false;
c. adjudicating the challenge by use of an adjudication component accessing a third corpus of information wherein the adjudication determines whether the challenging agent evaluation has falsified the asserting agent claim determination; and
d. allocating a bounty to the challenging agent if the adjudication determines that the challenging agent evaluation falsifies the asserting agent claim determination.

2. The method of claim 1 further assessing the claim for falsifiability prior to evaluating the claim by use of a challenging agent wherein the asserting agent modifies the claim to be falsifiable if the assessment determines that the claim is not falsifiable.

3. The method of claim 1 wherein the asserting agent contributes to the bounty.

4. The method of claim 1 further allocating the bounty to the asserting agent if the adjudication determines that the challenging agent evaluation does not falsify the asserting agent claim determination.

5. The method of claim 1 further accepting from the challenging agent a fee or a contribution to the bounty prior to the adjudication of the challenge.

6. The method of claim 1 further assessing the claim by use of one or more sponsoring agents wherein each of the one or more sponsoring agents contributes to the bounty if its assessment determines the claim to be true.

7. The method of claim 6 further determining by use of the asserting agent a minimum amount to be contributed to the bounty by the one or more sponsoring agents.

8. The method of claim 6 further determining by use of the asserting agent a time period during which sponsoring agents can contribute to the bounty.

9. The method of claim 6 further allocating a portion of the bounty to the asserting agent and the remainder of the bounty to each of the one or more sponsoring agents in relation to each of the one more sponsoring agent's contribution to the bounty.

10. The method of claim 1 further evaluating the claim by use of a plurality of challenging agents each accessing a corpus of information associated with each of the plurality of challenging agents wherein each evaluation determines the claim to be false, and adjudicating each challenge serially until the adjudication determines that the adjudicated challenging agent evaluation falsifies the asserting agent claim determination.

11. The method of claim 10 further determining by use of the asserting agent a time period during which the plurality of challenging agents can evaluate the claim and the adjudication component can adjudicate the challenging agent evaluation.

12. The method of claim 1, wherein step (b) comprises evaluating the claim by use of a challenging agent accessing a second corpus of information wherein the evaluation determines the claim to be false.

13. The method of claim 12 further assessing the claim by use of one or more sponsoring agents wherein each of the one or more sponsoring agents contributes to the bounty if its assessment determines the claim to be false.

14. A system for vetting claims, the system comprising:
a. a processor and memory configured to execute software instructions;
b. a campaign component configured to receive campaign information from an asserting agent wherein the campaign information includes a claim;
c. a sponsor component configured to receive sponsor information from a sponsoring agent wherein the sponsor information includes sponsorship bounty contribution;
d. a challenge component configured to receive challenge information from a challenging agent wherein the challenge information includes evidence to falsify the claim;
e. an adjudication component configured to assess the claim and the challenge information and to allocate the bounty based on the assessment wherein the assessment determines if the challenge information falsifies the claim;
f. a data store configured to store campaign information, sponsor information, challenge information, and adjudications as campaigns proceed through a workflow processed by the system; and
g. a user communication component configured to send communications to campaign participants.

15. The system of claim 14 wherein the campaign component provides feedback to the asserting agent.

16. The system of claim 14 wherein the campaign component is further configured to receive from the asserting agent a contribution to the bounty.

17. The system of claim 14 wherein the adjudication component is further configured to allocate the bounty to the asserting agent based on the assessment wherein the assessment determines if the challenge information does not falsify the claim.

18. The system of claim 14 wherein the challenge component is further configured to receive from the challenging agent a fee for making a challenge.

19. The system of claim 14 wherein the sponsor component is further configured to receive information from a plurality of sponsoring agents.

20. The system of claim 19 wherein the campaign component is further configured to receive from the asserting agent an indication of a minimum amount to be contributed to the bounty by the one or more sponsoring agents.

21. The system of claim 19 wherein the campaign component is further configured to receive from the asserting agent an indication of time period during which the plurality of sponsoring agents can contribute to bounty.

22. The system of claim 19 wherein the adjudication component is further configured to allocate a portion of the bounty to the asserting agent and the remainder of the bounty to each of the one or more sponsoring agents in relation to each of the one more sponsoring agent's contribution to the bounty.

23. The system of claim 14 wherein the challenge component is further configured to receive challenge information from a plurality of challenging agents and the adjudication component is further configured to adjudicate each challenge serially.

24. The system of claim 23 wherein the campaign component is further configured to receive from the asserting agent an indication of time period during which the challenge component can receive challenge information from the plurality of challenging agents and the adjudication component can adjudicate the challenge information.

25. A computer-readable medium having computer executable instructions for performing a method comprising:
a. receiving a claim by use of an asserting agent wherein the asserting agent accessing a first corpus of information determines the claim to be true;
b. evaluating the claim by use of a challenging agent accessing a second corpus of information wherein the evaluation determines the claim to be false;
c. adjudicating the challenge by use of an adjudication component accessing a third corpus of information wherein the adjudication determines whether the challenging agent evaluation has falsified the asserting agent claim determination; and
d. allocating a bounty to the challenging agent if the adjudication determines that the challenging agent evaluation falsifies the asserting agent claim determination.

26. The computer-readable medium of claim 25 wherein said computer executable instructions include further assessing the claim for falsifiability prior to assessing the claim by use of a challenging agent wherein the asserting agent modifies the claim to be falsifiable if the assessment determines that the claim is not falsifiable.

27. The computer-readable medium of claim 25 wherein said computer executable instructions include the receiving a contribution to the bounty from the asserting agent.

28. The computer-readable medium of claim 25 wherein said computer executable instructions include further allocating the bounty to the asserting agent if the adjudication determines that the challenging agent evaluation does not falsify the asserting agent claim determination.

29. The computer-readable medium of claim 25 wherein said computer executable instructions include further accepting from the challenging agent a fee or a contribution to the bounty prior to the adjudication of the challenge.

30. The computer-readable medium of claim 25 wherein said computer executable instructions include further evaluating the claim by use of one or more sponsoring agents wherein each of the one or more sponsoring agents contributes to the bounty if its evaluation determines the claim to be true.

31. The computer-readable medium of claim 30 wherein said computer executable instructions include further determining by use of the asserting agent a minimum amount to be contributed to the bounty by the one or more sponsoring agents.

32. The computer-readable medium of claim 30 wherein said computer executable instructions include further determining by use of the asserting agent a time period during which sponsoring agents can contribute to bounty.

33. The computer-readable medium of claim 30 wherein said computer executable instructions include further allocating a portion of the bounty to the asserting agent and the remainder of the bounty to each of the one or more sponsoring agents in relation to each of the one more sponsoring agent's contribution to the bounty.

34. The computer-readable medium of claim 25 wherein said computer executable instructions include further evaluating the claim by use of a plurality of challenging agents each accessing a corpus of information associated with each of the plurality of challenging agents wherein each evaluation determines the claim to be false, and adjudicating each challenge serially until the adjudication determines that the adjudicated challenging agent evaluation falsifies the asserting agent claim determination.

35. The computer-readable medium of claim 34 wherein said computer executable instructions include further determining by use of the asserting agent a time period during which the plurality of challenging agents can evaluate the claim and the adjudication component and adjudicate the challenging agent evaluation.

36. The method of claim 1, wherein step (b) comprises evaluating the claim by use of a challenging agent accessing a second corpus of information wherein the evaluation determines the claim to be false.

37. The method of claim 30 further assessing the claim by use of one or more sponsoring agents wherein each of the one or more sponsoring agents contributes to the bounty if its assessment determines the claim to be false.
